(19) United States
(12) Patent Application Publication
(10) Pub. No.: US 2017/0341136 A1
(43) Pub. Date: Nov. 30, 2017

(54) OIL-IN-WATER SILICONE EMULSION COMPOSITION FOR DIE CASTING RELEASE AGENT

(71) Applicant: Wacker Chemie AG, Munich (DE)

(72) Inventors: Airi SENGOKU, Ibaraki (JP); Shinichi ARAKI, Ibaraki (JP)

(73) Assignee: Wacker Chemie AG, Munich (DE)

(21) Appl. No.: 15/536,322

(22) PCT Filed: Dec. 18, 2015
(86) PCT No.: PCT/EP2015/080568

§ 371 Date: Jun. 15, 2017

(30) Foreign Application Priority Data
Dec. 24, 2014 (JP) 2014-260541

(51) Int. Cl. B22D 17/20; B01F 17/54; C08G 77/00; C08J 3/03

(52) U.S. Cl. CPC B22D 17/2007; C08J 3/03; B01F 17/0071; B22D 17/2038; C08G 77/80

(57) ABSTRACT

Organopolysiloxane emulsions having improved release properties when employed in die casting, contain an organopolysiloxane with long chain alkyl groups and/or aryl groups, and a partially hydrophobicized silica as an emulsifying agent.

### CROSS REFERENCE TO RELATED APPLICATIONS

This application is the U.S. National Phase of PCT Appln. No. PCT/EP2015/080568 filed Dec. 18, 2015, which claims priority to Japanese Application 2014-260541, filed Dec. 24, 2014 the disclosures of which are incorporated in their entirety by reference herein.

### BACKGROUND OF THE INVENTION

### 1. Field of the Invention

The present invention relates to an oil-in-water emulsion composition for a die casting release agent that contains an organopolysiloxane as the oil component.

### 2. Description of the Related Art

In the die casting of nonferrous metal products such as aluminum, zinc, and magnesium products, release has agents have been used for the purpose of improving releasability from the die by, for example, preventing adhesion of the molten metal and reducing friction during removal from the die. In such release agents for a die-casting die, organopolysiloxanes are well known as a principal component for imparting releasability. It is also known that such organopolysiloxanes are used in the form of an oil-in-water emulsion composition for environmental and safety reasons because, for example, the risk of fuming and ignition is small.

For example, Japanese Patent Application Laid-Open No. 2013-166176 proposes that dimethylpolysiloxanes having specific structures respectively modified with a long chain alkyl group and an aralkyl group are dispersed in water and used as a die casting release agent in the form of emulsion. It has been known that modified dimethylpolysiloxanes having a dimethylpolysiloxane chain partially substituted with a long chain alkyl group or an aromatic group such as a phenyl group or an aralkyl group has improved heat resistance because of the presence of the substituents, and is preferred for a die casting release agent. In Japanese Patent Application Laid-Open No. 2013-166176, the siloxane chain modified with a long chain alkyl group and an aralkyl group are provided within specific ranges of the chain structure, so that excellent adhesion of the release agent to a die and excellent releasability from the die at high temperature are achieved.

In die casting, the temperature of the die must be set to about 300° C. or higher in some cases. However, when the high-temperature characteristics of the release agent are insufficient, a problem occurs in that the casting surface of the product is roughened, for example, seizing, blowholes, molten aluminum flow marks, etc. occur, and this adversely affects the ease of removal of the product from the die and the quality of the product. Therefore, there is a need for further improvement in releasability from a high-temperature die.

### SUMMARY OF THE INVENTION

The present invention has been made to solve the foregoing problem in the conventional technology, and it is an object to solve the conventional problem, i.e., insufficient adhesion to and releasability from a die at high temperatures of about 300° C. or higher, to thereby provide a die casting release agent that can reduce roughness of the casting surface of a product. The present inventors have surprisingly and unexpectedly discovered, after extensive research, that these and other objects are achieved through use of an oil-in-water silicone emulsion containing no emulsifier.

### DETAILED DESCRIPTION OF THE PREFERRED EMBODIMENTS

Thus, the present invention pertains to the use of the following preferred embodiments:

[1] An oil-in-water emulsion composition as a die casting release agent, the oil-in-water emulsion composition comprising (A) an organopolysiloxane having an average chemical composition represented by the general formula (1),

R¹ₐSiO_{(4-a)/2} (1)

(B) silica particles, and (C) water,

In the formula (1), R¹s in the organopolysiloxane may be the same or different, and each R¹ is a group selected from a substituted or unsubstituted, saturated or unsaturated monovalent hydrocarbon group having 1 to 25 carbon atoms, a substituted or unsubstituted aromatic group having 6 to 30 carbon atoms, a hydroxyl group, an alkoxy group having 1 to 6 carbon atoms, and a hydrogen atom, and a is 1.5 to 2.5,

[2] The emulsion composition according to [1], wherein R¹s in the organopolysiloxane which is the component (A) represented by the general formula (1) include an alkyl group having 5 to 25 carbon atoms and/or an aromatic group having 6 to 30 carbon atoms.

[3] The emulsion composition according to [1] or [2], wherein, when R-s in the organopolysiloxane which is the component (A) represented by the general formula (1) include an aromatic group, the aromatic group is an aralkyl group having 7 to 25 carbon atoms.

[4] The emulsion composition according to any of [1] to [3], wherein each of the silica particles which are the component (B) has, on a surface thereof, a hydrophobic portion and a silanol group and is located in a water phase of an emulsion at a boundary between the water phase and an oil phase of an oil droplet of the organopolysiloxane (A).

[5] A die casting release agent containing the emulsion composition according to any of [1] to [4].

When the silicone emulsion composition of the present invention is used as a release agent for a die-casting die, adhesion to the die at a temperature setting of about 300° C. or higher is favorable, and resistance to removal from the high-temperature die is small, so that the cast can be easily released from the die. Therefore, roughness of the casting surface due to seizing, blowholes, molten aluminum flow marks, etc. is significantly reduced, and releasability from the high temperature die is excellent. When the emulsion composition of the present invention is used as a release agent, the cast obtained has high paintability, which is an unexpected effect.

The present invention will next be described in more detail. The component (A) in the present invention is an organopolysiloxane having an average chemical composition represented by the general formula (1). The general formula (1) represents an average chemical composition of the structure of a siloxane unit in the organopolysiloxane known as a so-called silicone oil. R¹ₐSiO_{(4-a)/2 (}1)

In the general formula (1), R¹ is a group selected from a substituted or unsubstituted, saturated or unsaturated monovalent hydrocarbon group having 1 to 25 carbon atoms, a substituted or unsubstituted aromatic group having 6 to 30 carbon atoms, a hydroxyl group, an alkoxy group having 1 to 6 carbon atoms, and a hydrogen atom. Examples of the unsubstituted monovalent hydrocarbon group may include: an alkyl group such as a methyl group, an ethyl group, a propyl group, a butyl group, a pentyl group, a hexyl group, a heptyl group, an octyl group, a nonyl group, a decyl group, a dodecyl group, a tetradecyl group, a hexadecyl group, and an octadecyl group; a cycloalkyl group such as a cyclopentyl group and a cyclohexyl group; and an unsubstituted hydrocarbon group such as a vinyl group, an allyl group, and a butenyl group. Examples of the unsubstituted aromatic group may include an aryl group such as a phenyl group, a methylphenyl group, and an ethylphenyl group; and an aralkyl group such as the 2-phenylethyl and 2-phenylpropyl groups. Examples of the substituents of the monovalent hydrocarbon group and the aromatic group may include a halogen atoms such as fluorine, chlorine, and bromine; alkoxy groups; amino groups; aminoalkyl groups; glycidyl groups; acyl groups; carboxyl groups; and nitrile groups. Examples of alkoxy groups in R¹ may include a methoxy group, an ethoxy group, a propoxy group, and a butoxy group.

R¹s in the general formula (1) in a molecule may be the same or different. Preferably, the molecule has a short chain alkyl group having 1 to 4 carbon atoms, preferably a methyl group or an ethyl group, and further contains a long chain alkyl group having 5 to 25 carbon atoms and/or an aromatic group having 6 to 30 carbon atoms. The long chain alkyl group and aromatic group are known as a substituent used for dimethylpolysiloxanes known as a silicone oil to impart thermal decomposition resistance. Preferably, the organopolysiloxane (A) in the present invention that is a principal component of the release agent used for a die-casting die at a temperature of about 300° C. or higher contains both a long chain alkyl group and an aromatic group simultaneously, in order for the release agent to have both heat resistance and die releasability.

In the most preferred organopolysiloxane, which is the component (A) in the present invention, R¹s in the general formula (1) include a long chain alkyl group having 5 to 25 carbon atoms and/or an aralkyl group having 7 to 25 carbon atoms. The organopolysiloxane containing both a long chain alkyl group and an aralkyl group is generally known as an alkyl-aralkyl-modified silicone, and specific examples thereof may include a long chain alkyl-aralkyl polysiloxane, a long chain alkyl-aralkyl-dimethylpolysiloxane, a long chain alkyl-aralkyl-dimethyl-methylethylpolysiloxane, an aralkyl polysiloxane, an aralkyl-dimethylpolysiloxane, and an aralkyl-dimethyl-methylethylpolysiloxane. In the organopolysiloxane (A) containing a long chain alkyl group and/or an aralkyl group, the amount of the siloxane unit having the long chain alkyl group is 0 to 80%, the amount of the siloxane unit having the aralkyl group is 15 to 80%, and the amount of a remaining siloxane unit, which is a unit having an alkyl group having 1 to 4 carbon atoms, is 0 to 90%.

The subscript, “a,” in the general formula (1) represents the average number of R¹s bonded to the silicon atom in a siloxane unit and is within the range of 1.5 to 2.5 and preferably 1.8 to 2.2. The molecular structure of the organopolysiloxanes having the average chemical composition represented by the general formula (1) is not limited to a liner chain, and the organopolysiloxanes may have a branched structure. Preferably, the organopolysiloxanes have a linear chain structure. The organopolysiloxanes in the present invention can be produced by any method known to persons skilled in the art.

No limitation is imposed on the viscosity at 25° C. of the organopolysiloxane represented by the general formula (1), but a preferred range of the viscosity is within 1×10¹ to 5×10⁷ mPa·s. When the viscosity is within the above range, adhesion to a heated die becomes favorable, and excellent releasability from the high-temperature die can be obtained. When the viscosity is lower than 1×10¹ mPa·s, adhesion is poor. When the viscosity is higher than 5×10⁷ mPa·s, emulsification is difficult to achieve. The viscosity is more preferably within the range of 1×10² to 5×10⁵ mPa·s.

No limitation is imposed on the amount of the component (A) contained in the emulsion composition of the present invention, but the amount is preferably within the range of 1 to 70% by mass. If the contained amount is less than 1% by mass, the emulsion does not have sufficient stability. If the contained amount exceeds 70% by mass, the viscosity of the emulsion becomes high. In this case, for example, its handleability deteriorates, or a problem occurs in the storage stability of the emulsion. The contained amount is more preferably within the range of 30 to 60% by mass.

The silica particles, which are the component (B) in the present invention, are silicon dioxide particles produced by a synthesis method and contain no mineral silica such as diatomite and crystalline quartz. Examples of the silicon dioxide produced by the synthesis method may include fine powders by dry processes such as fumed silica, pyrogenic silica, and fused silica, precipitated silica by a wet process, and colloidal silica by a wet process. These are well known to persons skilled in the art. Of these, pyrogenic silica, precipitated silica, or colloidal silica is preferably used. The silica particles (B) in the present invention may be hydrophilic silica with silanol groups remaining on its surface or may be hydrophobic silica obtained by silylating the silanol groups on the surface.

The hydrophobic silica can be produced by any known method in which hydrophilic silica is treated with halogenated organosilicon such as methyltrichlorosilane, an alkoxysilane such as a dimethylalkoxysilane, a silazane, or a low-molecular weight methyl polysiloxane. Such silica particles must be a fine powder having a specific surface area of 2 to 350 m²/g in a dry state and preferably 50 to 300 m²/g. Silica particles having a large diameter are not preferred because large particles may remain on the surface of a die when the emulsion composition is used as a die casting release agent. The amount of the silica particles (B) in the emulsion composition of the present invention is 0.1 to 30% by mass and preferably 0.2 to 10% by mass.

Preferably, the silica particles (B) in the present invention each have, on the surface thereof, hydrophobic portions and silanol groups and can be located in a water phase of the emulsion at a boundary between the water phase and an oil phase of an oil droplet of the organopolysiloxane (A). On the surfaces of such silica particles, silanol groups, which are hydrophilic groups, and silanol groups having been subjected to hydrophobic treatment are present at a prescribed ratio, so that the balance between the hydrophilicity and hydrophobicity of the particles is controlled. The silica particles are thereby located at the oil phase/water phase boundaries of the oil droplets of the organopolysiloxane (A) and exert an emulsification function similar to that of conventional surfactants. In a die casting release agent composition, a surfactant is used to emulsify and stabilize the composition but does not function advantageously in the step of applying the release agent to a die or in terms of releasability. A negative effect of the surfactant is that, for example, since breakage of the emulsion is less likely to occur during spraying onto a die, the oil component adheres to the die insufficiently, and this may cause release failure etc. One method to compensate for the insufficient adhesion is to spray a large amount of a water-based release agent containing a surfactant onto a die. However, the water-based release agent flowing down from the die causes an environmental problem such as an increase in the burden of wastewater treatment, so that it is contemplated to reduce the amount of the emulsifier in the composition. In the present invention, the silica used has, on its surface, hydrophobic portions and silanol groups. In this case, the silica is located at the oil phase/water phase boundaries of the oil droplets of the organopolysiloxane (A), and the oil droplets are stabilized even though an ordinary surfactant is not present. Therefore, the effect of improving adhesion in the step of applying the release agent and releasability from the die is achieved. The silica with the balance between the hydrophilicity and hydrophobicity on the surface controlled as described above can be produced by a known method. For example, the silica described above can be produced using a known hydrophobic silica production method in which silica particles are silylated by a dry or wet process. Specifically, the silica can be produced by controlling the degree of silylation. For example, the silica can be produced by reacting non-silylated silica with a silylating agent, for example, a chlorosilane such as methyltrichlorosilane or dimethyldichlorosilane, a silazane, or a polydimethylsiloxane, at a temperature of 50 to 330° C. in the presence of an inert gas.

In the silica particles having hydrophobic portions and silanol groups which are preferably used as the component (B) in the present invention, the ratio of silanol remaining after the silylation to the silanol groups before the silylation is preferably within the range of 50 to 95%. If the ratio of the remaining silanol is less than 50% or exceeds 95%, the function corresponding to the function of a surfactant at an oil phase/water phase boundary cannot be obtained. The degree of silylation or the ratio of remaining silanol can be determined by measurement of the content of carbon by elementary analysis or measurement of the amount of reactive silanol groups remaining on the surface of the silica. The silica particles used for the preparation may include particles with their entire surface silylated or particles with their entire surface not silylated. Any particles having an overall silylation ratio within the above range and capable of exerting the necessary emulsification function can be used.

No limitation is imposed on the amount of carbon contained in the silica particles having hydrophobic portions and silanol groups and used preferably as the component (B) in the present invention, so long as the purpose of obtaining the function as a surfactant can be achieved. The contained amount of carbon is 0.1 to 20%, preferably 0.1 to 15%, and more preferably 0.1 to 10%.

When the silica particles having hydrophobic portions and silanol groups are used as the component (B) in the present invention, no limitation is imposed on the amount of the silica particles contained in the emulsion composition. The amount of the silica particles is preferably within the range of 1 to 10% by mass. If the amount of the silica particles is less than 1% by mass, the storage stability of the emulsion deteriorates. If the amount of the silica particles exceeds 10% by mass, the viscosity of the emulsion becomes high, so that its handleability during dilution deteriorates. The amount of the silica particles is more preferably within the range of 2 to 6% by mass.

No particular limitation is imposed on the water (C) in the present invention, but the water used is preferably ion exchanged water. The pH of the water is preferably within the range of 2 to 12 and more preferably within the range of 4 to 10. The use of mineral water is not recommended. When mineral water is used, it is preferable to use it in combination with a metal deactivator etc. The amount of water added for emulsification is an amount corresponding to 40 to 90% by mass and preferably 40 to 60% by mass in the emulsion of the present invention. The emulsion composition of the present invention is stable when diluted with water and can be diluted after the emulsion is prepared, and no particular limitation is imposed on the amount of water in the diluted emulsion.

In the composition of the present invention, if the component (B) is not the silica particles that have hydrophobic portions and silanol groups with the balance between the hydrophilicity and hydrophobicity controlled so that the function as a surfactant is obtained, a surfactant may be used in order to disperse the component (A) or the silica particles having no surfactant function in the water phase (C). Even when the component (B) is the silica particles with the balance between the hydrophilicity and hydrophobicity controlled so that the function as a surfactant is obtained, a small amount of a surfactant may be used in order to improve storage stability and dilution stability, so long as the object of the present invention is not impaired. No particular limitation is imposed on the surfactant. Any surfactant used to prepare a silicone emulsion can be used, and any of anionic, cationic, amphoteric, and nonionic surfactants can be used. One type of surfactant may be used alone, or a combination of two or more types may be used.

No particular limitation is imposed on the method of preparing the emulsion composition of the present invention, and the emulsion composition can be prepared by a known method. The emulsion composition can be produced by mixing and emulsifying the above-described components using a commonly used mixer suitable for preparation of the emulsion, such as a homogenizer, a colloid mill, a homomixer, or a high-speed stator rotor mixer. When silica particles with the balance between the hydrophilicity and hydrophobicity not controlled and having no surfactant function are used as the component (B), emulsification can be achieved using any of a method including mixing and stirring a surfactant and all the components (A) to (C) to prepare an oil-in-water emulsion and a method including stirring a surfactant and the water (C) to prepare an aqueous solution of the surfactant and adding the organopolysiloxane, which is the component (A), and silica particles having no surfactant function to the prepared solution under stirring to obtain an oil-in-water emulsion. Even when silica particles with the balance between the hydrophilicity and hydrophobicity controlled so that the particles have the surfactant function are used as the component (B), any of a method including mixing and stirring all the components (A) to (C) to prepare an oil-in-water emulsion and a method including stirring silica particles (B) having the surfactant function and water (C) to prepare an aqueous silica dispersion liquid and then adding the organopolysiloxane, which is the component (A), to the prepared solution under stirring to obtain an oil-in-water emulsion can be used. A method including preparing first an aqueous dispersion liquid of silica particles having the surfactant function and then preparing an oil-in-water emulsion is preferred because the diameter of the particles in the emulsion can be easily controlled and because of the stability of the emulsion.

### EXAMPLES

The present invention will next be described in more detail, but the present invention is not limited to the following Examples. Methods for preparing fine silica particles, measuring the BET surface area of the silica particles; measuring the amount of non-silylated silanol groups remaining on the silica particles; measuring the amount of carbon contained in the silica particles; preparing an aqueous dispersion of silica; measuring viscosity; measuring release resistance; evaluation of a casting surface, and evaluating paintability in the Examples are described below. All the viscosity values are values at a temperature of 25° C.

### Method of Preparing Fine Silica Particles (Silica 1):

Partial silylation of silica particles used in the Examples was performed using a method including reacting dimethyldichlorosilane with silanol groups. Specifically, HDK® N20 manufactured by Wacker Chemie AG was selected as the silica used as a starting material, and a method shown in Example 1 of Japanese Patent Application Laid-Open No. 2004-203735 was used to prepare “silica 1” as silica particles, which are the component (B) used in Examples 1 and 2. Silica 1 had a BET specific surface area of 184 m²/g. The amount of remaining non-silylated silanol was about 70%, and the amount of carbon in the silica was about 1%.

### Method of Measuring BET Surface Area of Silica Particles

The BET surface area of the silica particles was measured according to DIN66131 and DIN66132.

### Method of Measuring Amounts of Non-silylated Silanol Groups Remaining on Silica Particles:

The amount of non-silylated silanol groups remaining on the silica particles was obtained by dividing the amount of silanol groups on the surfaces of the silica particles after the silylation by the amount of silanol groups on the surfaces of the silica particles before the silylation. The amount of silanol groups on the surfaces of the silica particles was measured by acid-base titration according to the method in G. W. Sears, Anal. Chem. 28(12), (1950), 1981.

### Method of Measuring Amount of Carbon Contained in Silica Particles:

The amount of carbon contained in the silica particles was determined by measuring the weight percentage of carbon atoms by elementary analysis. A sample was burnt at 1,000° C. or higher in a flow of oxygen, and identification and quantification were performed by infrared absorption spectroscopy of carbon dioxide generated.

### Method of Preparing Water Dispersion Liquid of Silica (Silica Dispersion Liquid 1):

As a method of preparing the silicone emulsion composition of the present invention, a method including preparing a dispersion of fine silica particles in water in advance and feeding the component (A) to the dispersion liquid was performed. 9.7 parts by mass of silica 1, which is partially hydrophobic silica, and 90.3 parts by mass of purified water were placed in a stainless steel beaker, and silica 1 was dispersed in the water using an Ultra-Turrax® mixer to obtain “silica dispersion liquid 1.” The silica dispersion liquid 1 obtained had a pH of 5.3 and a viscosity of 155 mPa·s. The pH of the dispersion was measured using indicator strips.

### Method of Measuring Viscosity:

The viscosity of the dispersion was measured using 0.5 mL of an emulsion sample at a temperature of 25° C. with a cone-plate viscometer BROOKFIELD DV-11 Pro VISCOMETER CPE 52 (manufactured by BROOKFIELD). The shear velocity during the measurement was 150 5⁻¹.

### Method of Measuring Release Resistance:

First, a test piece (material: SKD61, 200 mm×200 mm×thickness 30 mm) with an embedded thermocouple included with a releasability tester (product name: Lub tester U) manufactured by MEC International Co., Ltd. was heated using a commercial external heater. Next, the test piece was erected vertically and cooled to a preset temperature, and then the emulsion diluted 100-fold with water in advance was sprayed onto the test piece from nozzles under the conditions of a spraying time of 1 second and an air pressure of 0.4 MPa with the number of times of spraying being 1.

Immediately after spraying, the test piece was placed horizontally on the main body of the tester, and a ring manufactured by MEC International Co., Ltd. was placed at the center of the test piece. Then molten aluminum (ADC12, temperature: 680° C.) was poured into the ring and cooled for 40 seconds to solidify the aluminum. Immediately after solidification, an iron weight was gently placed on the solidified aluminum (product number: ADC12), and release resistance was measured while the ring was pulled in a horizontal direction using gears of the tester. The measurement was performed twice, and the average value was used as the release resistance value.

### Evaluation of Casting Surface:

In the evaluation of a casting surface (release surface), a surface in contact with the bottom surface of an aluminum piece, i.e., a metal plate, was defined as a release surface, and the casting surface was evaluated after the measurement of the release resistance. The casting surface was evaluated as “C” when blowholes, seizing, and many molten aluminum flow marks were found and the casting surface was rough (60% or more of the surface area), as “B” when part of the casting surface was rough (30% or more and less than 60% of the surface area), as “A” when roughness was found only in small portions (10% or more and less than 30% of the surface area), and as “AA” when the casting surface was not rough at all and was flat and smooth (less than 10%).

### Method of Evaluating Paintability:

Paintability was evaluated as follows. 1 g of the emulsion diluted so as to have a solid content of 10% was weighed into an aluminum cup (diameter: 6 cm, height: 2 cm) and then dried in an electric oven under the condition of 200° C./2 hours. Four parallel straight lines with a length of about 3 to 4 cm were drawn on the dried coating with an oil-based pen, and the paintability was evaluated from the oil-based pen ink repellency of the treated coating according to the following evaluation criteria.

A: No repellency. B: Repellency was found in part of the coating. C: Repellency was found on the entire coating.

### Example 1

47.5 parts by mass of component (A), i.e., organopolysiloxane 1 modified with a long chain alkyl group and an aralkyl group (WACKER® GM 191 RELEASE AGENT, manufactured by Wacker Chemie AG) having a viscosity of 5.0×10³ mPa·s and 1 part by mass of benzisothiazolinone used as an antiseptic were added to 51.5 parts by mass of the silica dispersion liquid 1. Then the mixture was stirred continuously using an Ultra-Turrax® mixer to prepare an emulsion composition in Example 1. The release resistance of the prepared emulsion was measured according to the above-described measurement method, and the roughness of the release surface (casting surface) was evaluated according to the above-described evaluation method. The evaluation results are shown in TABLE 1.

### Example 2

An emulsion composition in Example 2 was prepared in the same manner as in Example 1 except that organopolysiloxane 2 modified with a long chain alkyl group and an aralkyl group (WACKER® TN SILICONE RELEASE AGENT, manufactured by Wacker Chemie AG) having a viscosity of 1.2×10³ mPa·s was used as the component (A). The release resistance of the prepared emulsion composition was measured according to the above-described measurement method, and the roughness of the release surface (casting surface) was evaluated according to the above-described evaluation method. The evaluation results are shown in TABLE 1.

### Comparative Example 1

50.0 parts by mass of the same component as the component (A) in Example 1, i.e., organopolysiloxane 1 modified with a long chain alkyl group and an aralkyl group (WACKER® GM 191 RELEASE AGENT, manufactured by Wacker Chemie AG) having a viscosity of 5.0×10³ mPa·s, and further 5 parts by mass of a surfactant component, i.e., PO-EO decyl ether in which the number of moles of PO (polyethylene oxide) and the number of moles of EO (ethylene oxide) were 2 and 8, respectively, and 44.0 parts by mass of purified water were continuously stirred using Ultra-Turrax® mixer to prepare an emulsion composition in Comparative Example 1. The release resistance of the prepared emulsion composition was measured according to the above-described measurement method, and the roughness of the release surface (casting surface) was evaluated according to the above-described evaluation method. The evaluation results are shown in

### Comparative Example 2

An emulsion composition in Comparative Example 2 was prepared in the same manner as in Comparative Example 1 except that, instead of the component (A) used in Comparative Example 1, 50.0 parts by mass of organopolysiloxane 2 modified with a long chain alkyl group and an aralkyl group (WACKER® TN SILICONE RELEASE AGENT, manufactured by Wacker Chemie AG) and having a viscosity of 1.2×10³ mPa·s was used as component (A). The release resistance of the prepared emulsion was measured according to the above-described measurement method, and the roughness of the release surface (casting surface) was evaluated according to the above-described evaluation method. The evaluation results are shown in TABLE 1.

TABLE 1

| | | | | | Comparative | Comparative |
|---|---|---|---|---|---|---|
| Item | | | Example 1 | Example 2 | Example 1 | Example 2 |
| Component | (A) | Organopolysiloxane 1 | 47.5 | — | 50 | — |
| | | Organopolysiloxane 2 | — | 47.5 | — | 50 |
| | (B) | Silica 1 | 5 | 5 | — | — |
| | | PO, EO Decyl Ether | — | — | 5 | 5 |
| | (C) | Water | 46.5 | 46.5 | 44 | 44 |

| | Antiseptic (Benzisothiazolinone) | | 1 | 1 | 1 | 1 |
|---|---|---|---|---|---|---|
| Evaluation | Release Resistance | 300° C. | 7.7 | 11 | 8.1 | 7.6 |
| | Test (kgf) | 350° C. | 11.7 | 13.7 | 15.8 | 20.8 |

| | | | | |
|---|---|---|---|---|
| Evaluation of Casting Surface | AA | A | B | B |
| Evaluation of Paintability | A | A | B | B |

Unit of values of (A) to (C): parts by mass

1.-5. (canceled)

6. In a process for die casting where a release agent is applied to a die casting die, the improvement comprising applying as a relase agent, an oil-in-water emulsion composition comprising:
(A) an organopolysiloxane having an average chemical composition represented by the formula (1);
R¹ₐSiO_{(4-a)/2} (1)
(B) silica particles; and
(C) water,
wherein in the formula (1),
each R¹ independently is the same or different, and is a substituted or unsubstituted, saturated or unsaturated monovalent hydrocarbon group having 1 to 25 carbon atoms, a substituted or unsubstituted aromatic group having 6 to 30 carbon atoms, a hydroxyl group, an alkoxy group having 1 to 6 carbon atoms, or a hydrogen atom, and
a is 1.5 to 2.5,
wherein silica particles (B) comprise silylated silica particles with a controlled degree of silylation such that a ratio of remaining silanol groups after silylation to silanol groups before silylation is from 50 to 95%.

7. The process of claim 6, wherein at least one R¹ is an alkyl group having 5 to 25 carbon atoms and/or an aromatic group having 6 to 30 carbon atoms.

8. The process of claim 6, wherein when R¹ is an aromatic group, the aromatic group is an aralkyl group having 7 to 25 carbon atoms.

9. The process of claim 7, wherein when R¹ is an aromatic group, the aromatic group is an aralkyl group having 7 to 25 carbon atoms.

10. The process of claim 6, wherein the silica particles which are the component (B) have, on surfaces thereof, a hydrophobic portion and a silanol group, and the silica particles are located in a water phase of an emulsion at a boundary between the water phase and an oil phase of an oil droplet of the organopolysiloxane (A).

11. The process of claim 7, wherein the silica particles which are the component (B) have, on surfaces thereof, a hydrophobic portion and a silanol group, and the silica particles are located in a water phase of an emulsion at a boundary between the water phase and an oil phase of an oil droplet of the organopolysiloxane (A).

12. The process of claim 8, wherein the silica particles which are the component (B) have, on surfaces thereof, a hydrophobic portion and a silanol group, and the silica particles are located in a water phase of an emulsion at a boundary between the water phase and an oil phase of an oil droplet of the organopolysiloxane (A).

13. The process of claim 9, wherein the silica particles which are the component (B) have, on surfaces thereof, a hydrophobic portion and a silanol group, and the silica particles are located in a water phase of an emulsion at a boundary between the water phase and an oil phase of an oil droplet of the organopolysiloxane (A).

14. The process of claim 6, wherein the die casting die has a temperature of 300° C. or higher at a time prior to casting.
